(19) United States
(12) Patent Application Publication
(10) Pub. No.: US 2017/0047618 A1
(43) Pub. Date: Feb. 16, 2017

(54) CELL PACK, CHARGING DEVICE AND ELECTRIC TOOL

(71) Applicant: Hitachi Koki Co., Ltd., Tokyo (JP)

(72) Inventor: Toshiyuki SUZUKI, IBARAKI (JP)

(73) Assignee: Hitachi Koki Co., Ltd., Tokyo (JP)

(21) Appl. No.: 15/307,375

(22) PCT Filed: Apr. 27, 2015
(86) PCT No.: PCT/JP2015/062680

§ 371 Date: Oct. 28, 2016

(30) Foreign Application Priority Data
Apr. 30, 2014 (JP) 2014-094235

(51) Int. Cl. H01M 10/42; H02J 7/00; H01M 2/10

(52) U.S. Cl. CPC H01M 10/4257; H01M 2/1055; H02J 7/0013; H02J 7/007; H01M 2220/30

(57) ABSTRACT

The present invention provides a charging device, an electric tool and a cell pack which is provided with an IC tag to make it possible to identify the type of cell group. A cell pack includes: a cell group, having one or more secondary cells; a case for accommodating the cell group and provided with a connection part that can be connected to a charging device for charging the cell group and can be connected to an electric tool driven by discharging of the cell group; and an IC tag for storing cell information pertaining to the cell group.

### BACKGROUND OF THE INVENTION

1. Field of the Invention

The invention relates to a cell pack, a charging device and an electric tool.

2. Description of Related Art

In the conventional art, a cell pack accommodated with a cell group including one or more cells is used as a power source in various electric tools. The cell group of the cell pack is charged through a charging device. Said cell pack is known to include an identification resistor. The identification resistor includes built-in resistances representing a type (a rated voltage, a number of serial connections and a number of parallel connections of the cells constituting the cell group, etc.) of the cell group (Patent Document 1). Values of the identification resistor are read by a micro computer carried in the charging device or the electric tool connected to the cell pack. In this way, the type of the cell pack may be identified based on the values of the identification resistor and used in a charging control of the charging device or a discharging control of the electric tool.

### PRIOR ART DOCUMENT

### Patent Document

Patent Document 1: Japanese Patent Publication No. 2009-178012

### SUMMARY OF THE INVENTION

### Problems to be Solved by the Invention

However, when the identification resistor is used for identifying the type of the cell group, only dozens of the cell groups may be identified at the most if read errors in the micro computer carried in the charging device or the electric tool are taken into account. Consequently, with the type of the cell group becoming more diverse, it is difficult to achieve an appropriate charging control of the charging device or an appropriate discharging control of the electrical tool if the type may only be accurately identified for a part of the diverse cell groups.

In the light of this, the invention aims to provide a cell pack, a charging device and an electric tool, which are capable of identifying the type for the diverse cell groups.

### Technical Means for Solving the Problem

In order to solve aforementioned problem, the invention provides a cell pack, which includes: a cell group, including one or more secondary cells; a case, for accommodating the cell group and provided with a connection part, the connection part being connectable to a charging device for charging the cell group and connectable to an electric tool driven by discharging of the cell group; and an integrated circuit (IC) tag, for storing cell information pertaining to the cell group.

According to such configuration, the cell information pertaining to the cell group (i.e., the rated voltage, the number of parallel connections and the number of serial connections of the secondary cells constituting the cell group) may be stored in the IC tag. In this way, the charging device or the electric tool can read the information stored in the IC tag so the charging device or the electric tool can then accurately determine the type of the cell group to achieve the appropriate charging control or the appropriate discharging control. Further, in addition to the rated voltage, the number of parallel connections and the number of serial connections of the secondary cells constituting the cell group, the IC tag can also store a large amount of information including a rated charging current, a maximum charging current, a rated discharging current, a maximum discharging current, a termination current, etc., as the cell information pertaining to the cell group. In this way, the stored cell information may be used in the charging control or the discharging control to achieve an extreme fine control so more appropriate charging control or discharging control may be performed.

Further, preferably, the IC tag is disposed on an inner surface of the case.

According to such configuration, because the IC tag is disposed on the inner surface of the case, attachment of liquid drop, dust and dirt as well as impact from outside the case may be suppressed. In this way, a long life of the IC tag may be achieved.

Further, preferably, the case has an opposite wall. The opposite wall is opposite to the charging device or the electric tool when the connection part is connected to the charging device or the electric tool, and the IC tag is disposed on the opposite wall.

According to such configuration, when the connection part of the cell pack is connected to the charging device or the electric tool, the IC tag is located near the charging device or the electric tool. In this way, the charging device or the electric tool can read cell information stored in the IC tag more reliably and easily.

Further, it is preferable to further include a substrate, which is accommodated in the case and mounted with a circuit part connected to the cell group, where the IC tag is disposed on the substrate.

According to such configuration, the IC tag may be mounted on the circuit board in advance during an assembly procedure before the substrate is accommodated in the case. Thus, an assemblability of the cell pack may be improved.

In order solve aforementioned problem, the invention further provides a cell pack, which includes: a cell group, including one or more secondary cells; a circuit board, disposed above the cell group and connected to the secondary cells; a case, for accommodating the cell group and the circuit board and provided with a connection part; and an IC tag, disposed above the circuit board and storing cell information pertaining to the cell group.

According to such configuration, the cell group, the circuit board and the IC tag are provided in a sequence starting from the bottom in a vertical direction. In this way, since the connection part is disposed on an upper portion of the cell pack, the IC tag may be closer to a connection target. Accordingly, when the connection target includes a reader for reading information in the IC tag, the information in the IC tag may be reliably read by the connection target.

In said configuration, preferably, the IC tag is disposed avoiding a terminal part in the vertical direction.

According to such configuration, since the IC tag is disposed avoiding the terminal part, a size of the cell pack in the vertical direction may be suppressed from becoming larger.

Further, preferably, the connection part has a terminal. The terminal has one end connected to the circuit board and another end connected to an external equipment. The IC tag is disposed inside the case on an upper portion of the another end of the terminal or on a position lower than the upper portion in the vertical direction.

According to such configuration, the IC tag is located on an upper portion of the another end of the terminal or on a position lower than the upper portion in the vertical direction. In this way, the size of the cell pack in the vertical direction may still be suppressed from becoming larger even if the IC tag is disposed.

In order solve aforementioned problem, the invention further provides a cell pack, which includes: a cell group, including one or more secondary cells; a case, for accommodating the cell group and provided with a connection terminal part connected to a connection target; and an IC tag, for storing cell information pertaining to the cell group. The case is configured to connect the connection target by sliding along a first direction. The connection terminal part is disposed on a front side and the IC tag is disposed on a rear side in the first direction.

According to such configuration, the connection terminal part is disposed on the front side in the first direction, and thus the IC tag is disposed on the rear side. With such disposition, the IC tag 13 does not cause interferences when the cell pack is connected to the charging device or the electric tool serving as the connection target so the connection terminal part may be connected to the terminal part of the connection target.

In order solve aforementioned problem, the invention further provides a charging device, which is connectable to the cell pack. The cell pack includes a cell group and an IC tag. The cell group includes one or more secondary cells. The IC tag stores cell information pertaining to the cell group. The charging device includes: a reading member, capable of reading the cell information stored by the IC tag; and a charging control member, performing a charging control for the cell group based on the cell information read by the reading member.

According to such configuration, the charging device can read the cell information pertaining to the cell group stored in the IC tag included by the cell pack so the charging control may be performed based on the cell information. Thus, the charging device can appropriately charge the cell group which serves as the charging target.

Further, preferably, the reading member is disposed opposite to the IC tag when the cell pack is connected to the charging device.

According to such configuration, because the reading member is disposed opposite to the IC tag, the information stored in the IC tag may be read more reliably and easily.

Further, preferably, the cell pack is configured to connect above the charging device, and the IC tag and the reading member are disposed in an overlapping manner when inspecting from a vertical direction.

According to such configuration, because the IC tag and the reading member are located in an overlapping manner when inspecting from the vertical direction, a distance between the two may be reduced so the information of the IC tag may be reliably read.

In order solve aforementioned problem, the invention further provides a charging device, which is connectable to the cell pack. The cell pack includes a cell group, a connection terminal part and an IC tag. The cell group includes one or more secondary cells. The connection terminal part is connected to the cell group. The IC tag stores cell information pertaining to the cell group. The charging device includes: a charging terminal part, connected to the connection terminal part; a reading member, capable of reading the cell information stored by the IC tag; and a charging control member, performing a charging control for the cell group based on the cell information read by the reading member, and configured to connect the connection terminal part to the charging terminal part by sliding the cell pack along a first direction. The charging terminal part is disposed on a front side and the reading member is disposed on a rear side in the first direction.

According to such configuration, because the charging terminal part is disposed on the front side in the first direction and the reading member is disposed on the rear side, when the cell pack is slid to connect relative to the charging device along the first direction, the reading member does not cause interferences so the terminals may be connected to each other.

In order solve aforementioned problem, the invention further provides an electric tool, which is connectable to the cell pack. The cell pack includes a cell group and an IC tag. The cell group includes one or more secondary cells. The IC tag stores cell information pertaining to the cell group. The electric tool includes: a reading member, capable of reading the cell information stored by the IC tag; and a discharging control member, performing a discharging control for the cell group based on the cell information read by the reading member.

According to such configuration, the electric tool can read the cell information pertaining to the cell group stored in the IC tag included by the cell pack so the discharging control may be performed based on the cell information. Thus, the electric tool can perform the appropriate discharging control.

Further, preferably, the reading member is disposed opposite to the IC tag when the cell pack is connected to the electric tool.

According to such configuration, because the reading member is disposed opposite to the IC tag, the information stored in the IC tag may be read more reliably and easily.

Further, preferably, the cell pack is configured to connect below the electric tool, and the IC tag and the reading member are disposed in an overlapping manner when inspecting from a vertical direction.

According to such configuration, because the IC tag and the reading member are located in an overlapping manner when inspecting from the vertical direction, a distance between the two may be reduced so the information of the IC tag may be reliably read.

In order solve aforementioned problem, the invention further provides an electric tool, which is connectable to the cell pack. The cell pack includes a cell group, a connection terminal part and an IC tag. The cell group includes one or more secondary cells. The connection terminal part is connected to the cell group. The IC tag stores cell information pertaining to the cell group. The electric tool includes: a tool terminal part, connected to the connection terminal part; a reading member, capable of reading the cell information stored by the IC tag; and a discharging control member, performing a discharging control for the cell group based on the cell information read by the reading member, and configured to connect the connection terminal part to the tool terminal part by sliding the cell pack along a first direction. The tool terminal part is disposed on a front side and the reading member is disposed on a rear side in the first direction.

According to such configuration, because the tool terminal part is disposed on the front side and the reading member is disposed on the rear side in the first direction, when the cell pack is slid to connect relative to the electric tool along the first direction, the reading member does not cause interferences so the terminals may be connected to each other.

In the configuration of the cell pack, preferably, when the connection part is connected to the charging device, the charging control for the cell group is performed based on the cell information read by the charging device from the IC tag.

According to such configuration, because the charging control is performed based on the cell information, the appropriate charging control corresponding to the type of the cell group may be performed for charging the cell group.

Further, preferably, the cell information includes charging history information.

According to such configuration, because the cell information includes the charging history information, the deterioration degree of the cell group or the secondary cells may be determined according to the charging history information. In this way, the charging control taking the deterioration degree into account becomes viable so the more appropriate charging control may be performed.

Further, preferably, when the connection part is connected to the electric tool, the discharging control for the cell group is performed based on the cell information read by the electric tool from the IC tag.

According to such configuration, because the discharging control is performed based on the cell information, the more appropriate discharging control corresponding to the type of the cell group in the cell pack may be performed.

Further, preferably, the cell information includes discharging history information.

According to such configuration, because the cell information includes the discharging history information, the deterioration degree of the cell group or the secondary cells may be determined according to the discharging history information. In this way, the discharging control taking the deterioration degree into account becomes viable so the more appropriate discharging control may be performed.

In said configuration of the charging device it is preferable to further include an updating member, which is capable of updating the cell information stored in the IC tag.

According to such configuration, the cell information may be updated into newer cell information. Thus, the charging control may be performed based on the new information to achieve the more appropriate charging control.

Further, preferably, the cell information includes charging history information.

According to such configuration, the charging control may be performed based on the charging history information. Thus, the deterioration degree of the cell group included by the cell pack may be determined according to the charging history information so the charging control with determination on the deterioration degree taken into account becomes viable.

Further, preferably, the charging control member includes: a charging storage part, for storing the information used in the charging control; and a charging information transmission member, capable of transmitting the information to an external equipment.

According to such configuration, the charging control member can transmit the information used in the charging control and stored by the charging storage part to the external equipment. Thus, when the external equipment includes a LCD screen or the like, the information may be displayed on said monitor so a convenience may be improved for the users or serviceman from the cell maker.

In said configuration of the electric tool, it is preferable to further include an updating member, which is capable of updating the cell information stored in the IC tag.

According to such configuration, the cell information may be updated into newer cell information. Thus, the more appropriate discharging control based on the new information may be achieved.

Further, preferably, the cell information includes discharging history information.

According to such configuration, the charging control may be performed according to the charging history information. Thus, the deterioration degree of the cell group included by the cell pack may be determined according to the charging history information so the discharging control with determination of the deterioration degree taken into account becomes viable.

Further, preferably, the discharging control member includes: a discharging storage part, for storing the information used in the discharging control; and a discharging information transmission member, capable of transmitting the information to an external equipment.

According to such configuration, the discharging control member can transmit the information used in the discharging control and stored by the discharging storage part to the external equipment. Thus, when the external equipment includes the LCD screen or the like, the information may be displayed on said monitor so the convenience may be improved for the users or serviceman from the cell maker.

### Effects of the Invention

The cell pack, the charging device and the electric tool according to the invention are capable of identifying the type of the diverse cell groups.

### BRIEF DESCRIPTION OF THE DRAWINGS

FIG. 1 is a side view illustrating a partial cross section of the cell pack according to an embodiment of the invention.

FIG. 2 is a plane view illustrating the circuit board of the circuit board of the cell pack according to an embodiment of the invention.

FIG. 3 is a diagram illustrating information stored in the IC tag of the cell pack according to an embodiment of the invention.

FIG. 4 is a side view illustrating a partial cross section of the cell pack connected to the charging device according to an embodiment of the invention.

FIG. 5 is a side view illustrating a partial cross section of the cell pack connected to the electric tool according to an embodiment of the invention.

FIG. 6 is a schematic diagram illustrating the cell pack and the external equipment according to an embodiment of the invention.

FIG. 7 is a schematic diagram illustrating relative relations of the cell pack the charging device, the electric tool and the external equipment according to an embodiment of the invention.

FIG. 8 is a flowchart illustrating the charging control of the charging device according to an embodiment of the invention.

FIG. 9 is a diagram illustrating a first charging current decision table used in the charging control of the charging device according to an embodiment of the invention.

FIG. 10 is a diagram illustrating a second charging current decision table used in the charging control of the charging device according to an embodiment of the invention.

FIG. 11 is diagram illustrating process procedures of the charging control stored in the IC tag of the cell pack according to an embodiment of the invention.

FIG. 12 is a flowchart illustrating the discharging control of the electric tool according to an embodiment of the invention.

FIG. 13 is a diagram illustrating a maximum duty decision table used in the discharging control of the electric tool according to an embodiment of the invention.

FIG. 14 is a diagram illustrating a maximum duty corresponding to the deterioration degree of the cell pack in the discharging control of the electric tool according to an embodiment of the invention.

FIG. 15 is a side view illustrating a partial cross section of the cell pack according to a modification example in one embodiment of the invention.

### DESCRIPTION OF THE EMBODIMENTS

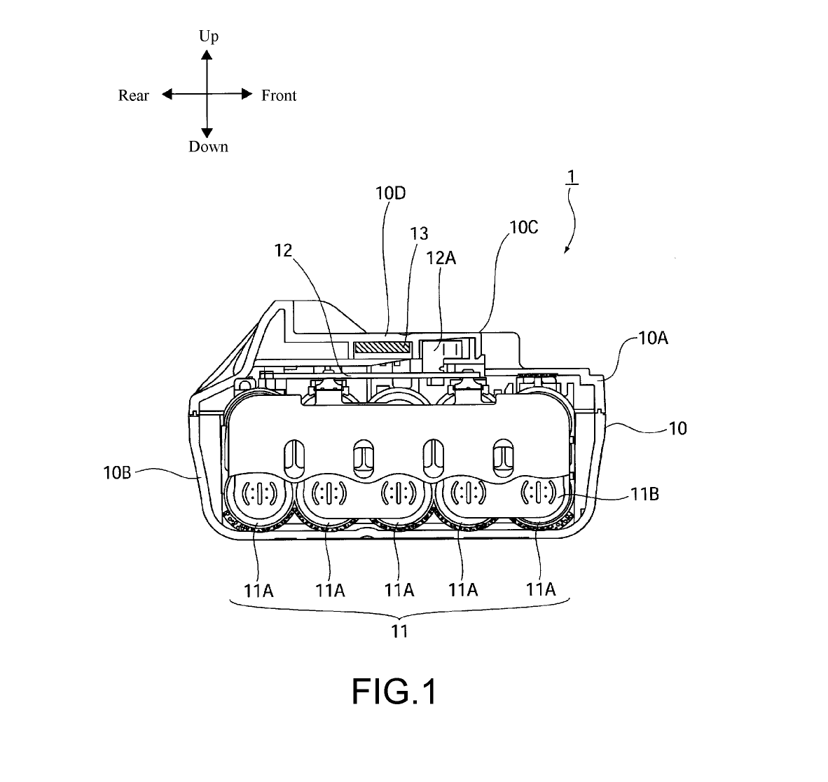

The cell pack of the invention, the charging device of the invention and the electric tool of the invention are described below with reference to FIG. 1 to FIG. 15.

First of all, a cell pack 1 in the embodiments of the invention, a charging device 2 in the embodiments of the invention and an electric tool 3 in the embodiments of the invention are described with reference to FIG. 1 to FIG. 14. Further, in FIG. 1, a top-to-bottom direction is defined as a down direction and its reverse direction is defined as an up direction; and a front-to-rear direction is defined as a rear direction and its reverse direction is defined as a front direction. Furthermore, when inspecting from the rear direction, a direction to the right is defined as a right direction and a direction to the left is defined as a left direction.

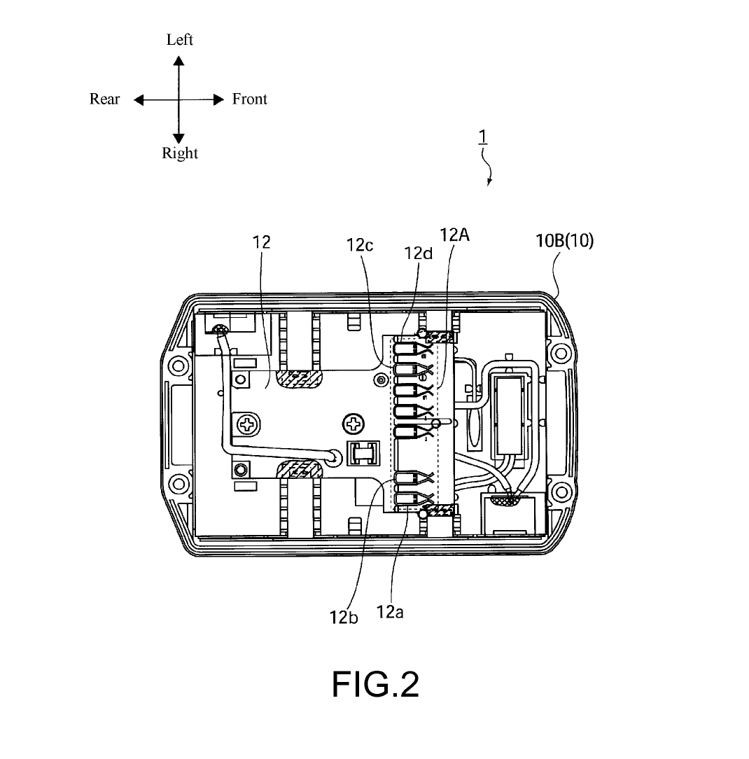

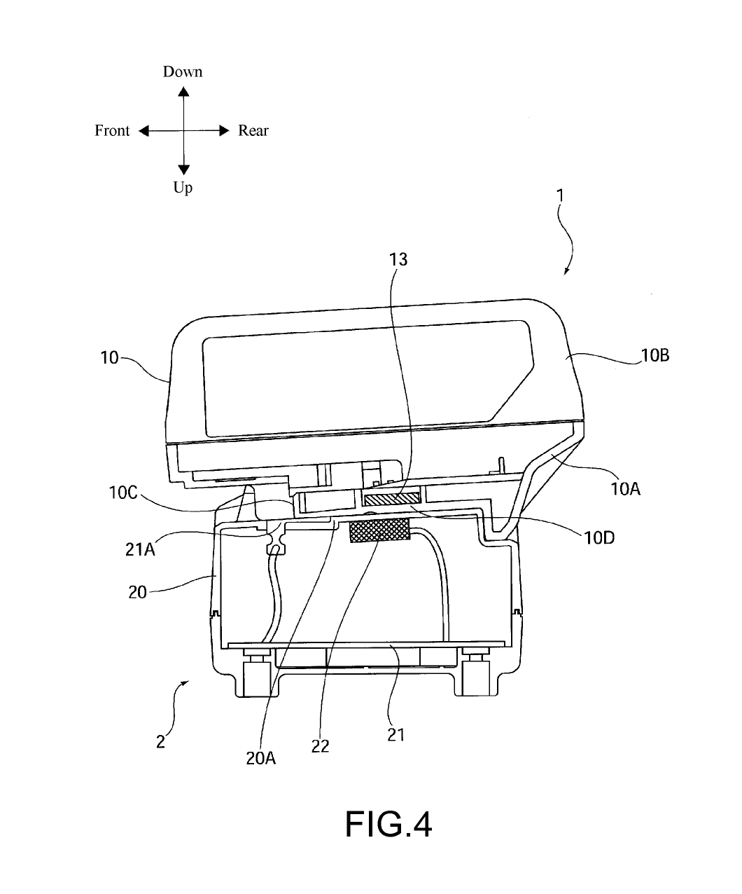

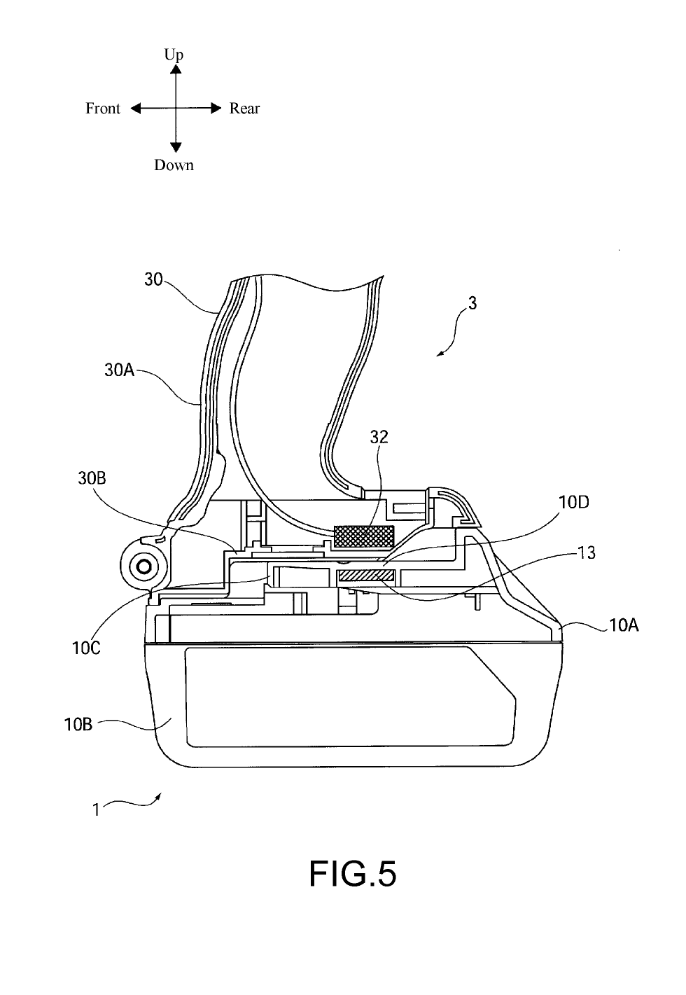

As shown in FIG. 1 and FIG. 2, the cell pack 1 is mainly constituted by a case 10, a cell group 11, a circuit board 12 and an IC tag 13. As shown in FIG. 4, the cell group 11 may be charged by connecting the cell pack 1 to the charging device 2. Moreover, as shown in FIG. 5, the electric tool 3 may be driven by discharging of the cell group 11 when the cell pack 1 is connected to the electric tool 3. The cell pack 1 is connected to the charging device 2 or the electric tool 3 serving as the connection target by sliding along a first direction from rear to front in FIG. 1.

The case 10 includes an upper case 10A and a lower case 10B are parts constituting an outline of the cell pack 1, and accommodating therein with the cell group 11, the circuit board 12 and the IC tag 13.

The upper case 10A constitutes substantially one half an upper portion of the case 10, and includes an equipment connection part 10C. The equipment connection 10C is formed into a shape connectable to the charging device 2 and connectable to the electric tool 3. The charging device 2 may be in electrical and mechanical connection with the cell pack 1 by connecting the equipment connection part 10C to the charging device 2. The electric tool 3 may be in electrical and mechanical connection with the cell pack 1 by connecting the equipment connection part 10C to the electric tool 3. Further, an opposite wall 10D is defined in the upper case 10A. The opposite wall 10D is opposite to the charging device 2 or the electric tool 3 when the cell pack 1 is connected to the charging device 2 or the electric tool 3. The lower case 10B constitutes substantially one half a lower portion of the case 10, and mainly provides a space for accommodating the cell group 11. The equipment connection part 10C is one example of the connection part.

The cell group 11 adopts a structure serially connecting five cells 11A together by a plurality of connection plates 11B. In the present embodiment, the cells 11A may be a rechargeable lithium Ion battery with a rated voltage of 3.60 V. The cells 11A are one example of the secondary cells.

The circuit board 12 is disposed above the cell group 11 inside the case 10, and includes a connection terminal part 12A. Also, an electrical circuit connected to the cell group 11 is mounted on the circuit board 12. The electrical circuit is connected to a protection IC. The circuit board 12 is one example of the substrate and the electrical circuit is one example of the circuit part.

As shown in FIG. 1, the connection terminal part 12A is disposed on the front side of an upper surface of the circuit board 12. As shown in FIG. 2, the connection terminal part 12A includes a plurality of terminals arranged and disposed along a left-right direction. The plurality of terminals include a charging positive terminal 12a, a discharging positive terminal 12b, a charging/discharging negative terminal 12c and a stop signal output terminal 12d. The connection terminal part 12A is disposed on the front side in the first direction and the IC tag 13 (to be described later) is disposed on the rear side of the connection terminal part 12A (i.e. the rear side in the first direction). With such disposition, the IC tag 13 does not cause interferences when the cell pack 1 is connected to the connection target so the connection terminal part 12A may be connected to a terminal part of the connection target.

The charging positive terminal 12a and the discharging positive terminal 12b are connected to a positive terminal of the cell 11A with the highest potential in the cell group 11 via the electrical circuit. The charging/discharging negative terminal 12c is connected to a negative terminal of the cell 11A with the lowest potential in the cell group 11 via the electrical circuit. The stop signal output terminal 12d is connected to the protection IC.

The protection IC monitors voltage for each of the cells 11A, and outputs a stop signal—which stops charging or discharging—from the stop signal output terminal 12d when an abnormal condition caused by over-charging or over-discharging occurs due to whatever reasons.

The 1C tag 13 is an IC chip of a non-contact transmission attached with a passive tag type antenna, and is disposed on an inner surface of the opposite wall 10D of the upper case 10A (the surface on the side of the cell group 11). Cell information pertaining to the cell group 11 is stored in IC tag 13. That is to say, the cell group 11, the circuit board 12 and the IC tag 13 are sequentially disposed from the bottom (a bottom surface of the lower case 10B) to the top inside the case 10, with the opposite wall 10D provided above by covering the IC tag 13. Further, the connection terminal part 12A is provided on the front side of the IC tag 13. In a vertical direction, the IC tag 13 is disposed on an upper portion of the connection terminal part 12A or on a position below (a position that is less protruded above than the connection terminal part 12A). Namely, the IC tag 13 is disposed on a position avoiding the connection terminal part 12A in the vertical direction (specifically, more rear than the connection terminal part 12A). When the cell pack 1 is connected to the charging device 2 or the electric tool 3, the connection terminal part 12A may be connected to the terminal part of the charging device 2 or the electric tool 3. In this way, the distance between the connection target (the charging device 2 or the electric tool 3) and the IC tag 13 may be reduced since the IC tag 13 is disposed near the connection terminal part 12A. Accordingly, the information of the IC tag 13 may be reliably read simply by disposing a reader/writer (to described later) on the connection terminal part of the connection target. Therefore, the IC tag 13 may be prevented from damages caused by external force since the opposite wall 10D is provided there above. Moreover, in the vertical direction, the IC tag 13 is disposed avoiding the connection terminal part 12A (the IC tag 13 is disposed on the rear side of the connection terminal part 12A in a front-rear direction of FIG. 1). Also, the IC tag 13 is located lower than an upper portion of the end of the connection terminal 12A which is not connected to the circuit board 12. Therefore, even if the IC tag 13 is disposed, the size of the cell pack 1 in the vertical direction does not become larger. By disposing the IC tag 13 in the space avoiding the connection terminal part 12A, the inner space of the case may be effectively utilized without increasing the size of the case 10.

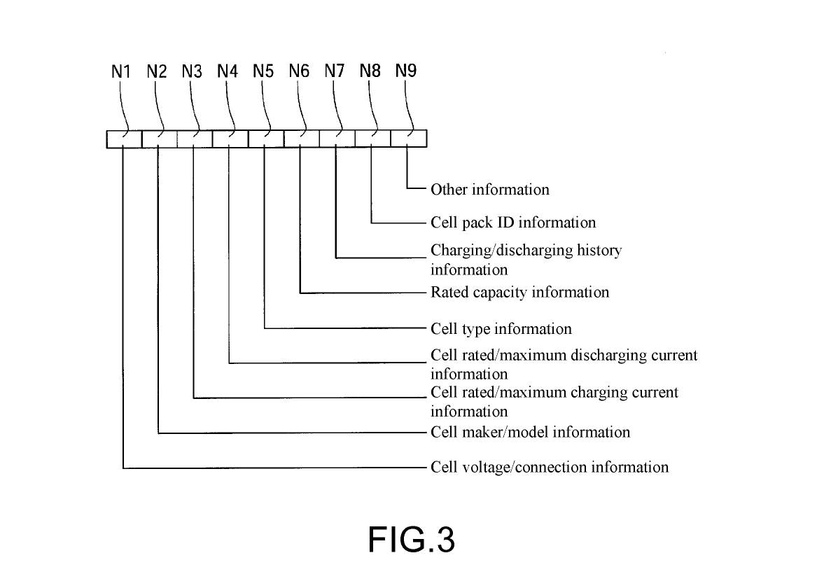

Next, the cell information pertaining to the cell group 11 is described below with reference to FIG. 3. FIG. 3 is a diagram conceptually illustrating a storage field of the IC tag 13, in which fields N1 to N9 each stores the cell information pertaining to the cell group 11. Further, the fields N1 to N6 and N8 are the storage fields restricted from updating (modifying, writing, etc.), whereas the fields N7 and N9 are the storage fields that can be updated.

The field N1 is known as “Cell voltage/connection information”, and stores a rated voltage, a maximum charging voltage, an over-discharging voltage, a connection type (i.e., the number of parallel connections, the number of serial connections, etc.) of each cell among the cells 11A constituting the cell group 11. Further, according to “Cell voltage/connection information”, the rate voltage, the maximum charging voltage, the over-discharging voltage and so on may be calculated for the entire cell group 11. In the present embodiment, the rated voltage is 3.60 V, the maximum charging voltage is 3.80 V, the over-discharging voltage is 3.40 V, the number of parallel connections is 1 and the number of serial connections is 5. As such, in the present embodiment, because each cell has the rated voltage being 3.60 V, the maximum charging voltage being 3.80 V and the number of serial connections being 5, the entire cell group 11 has the rated voltage being 18.0 V (3.60 V/cell×5 cells) and the maximum charging voltage being 19.0 V (3.80 V/cell×5 cells).

The field N2 is known as “Cell maker/model formation” and stores a name of a cell maker making the cell 11A and a model marked by the cell maker. In the present embodiment, the cells 11A have the cell maker being S and a model being AAAA

The field N3 is known as “Cell rated/maximum charging current information” and stores a rated charging current and a maximum charging current of the entire cell group 11. The rated charging current is a current suitable for reliably charging the cells 11A constituting the cell group 11 to a fully-charged state, and includes a current value decided by the cell maker taking characteristics and safety issue of the cells 11A into account. The maximum charging current is a maximum current value permissible in a short-term charging, such as a fast charging. In the present embodiment, the rated charging current is 4 A and the maximum charging current is 6 A. Further, the field N3 also stores a termination current value which is used for determining the fully-charged state in a constant current constant voltage control.

The field N4 is known as “Cell rated/maximum discharging current information” and stores a rated discharging current and a maximum discharging current of the cells 11A. The rated discharging current is a current value suitable for continuous discharging the cells 11A, which is a value decided by the cell maker taking characteristics and safety issue of the cells 11A into account. The maximum discharging current is a maximum current value permissible in a short-term discharging. In the present embodiment, the rated discharging current is 20 A and the maximum discharging current is 40 A.

The field N5 is known as “Cell type information” and store a shape (e.g., a cylindrical shape, a flat shape, etc.) of the cells 1A. In the present embodiment, the cells 11A are of the cylindrical shape.

The field N6 is known as “Rated capacity information” and stores a rated capacity of the cell group 11 including the cells 11A. In the present embodiment, the rated capacity of the cell group is 5 Ah.

The field N7 is known as “Charging/discharging history information” and stores a charging count, a total charged time, a model of the charging device used in charging, a discharging count, a total discharged time, a model of the electric tool used in discharging, an over-current count, an over-charged count and an over-discharged count. The charging count, the total charged time, the model of the charging device used in charging, the over-current count, the over-charged count, the over-discharged count are one example of the charging history information. Also, the discharging count, the total discharged time, the model of the electric tool used in discharging, the over-current count, the over-charged count, the over-discharged count are one example of the discharging history information.

The field N8 is known as “Cell pack ID information” and stores a built-in management number given when the cell pack 1 is manufactured.

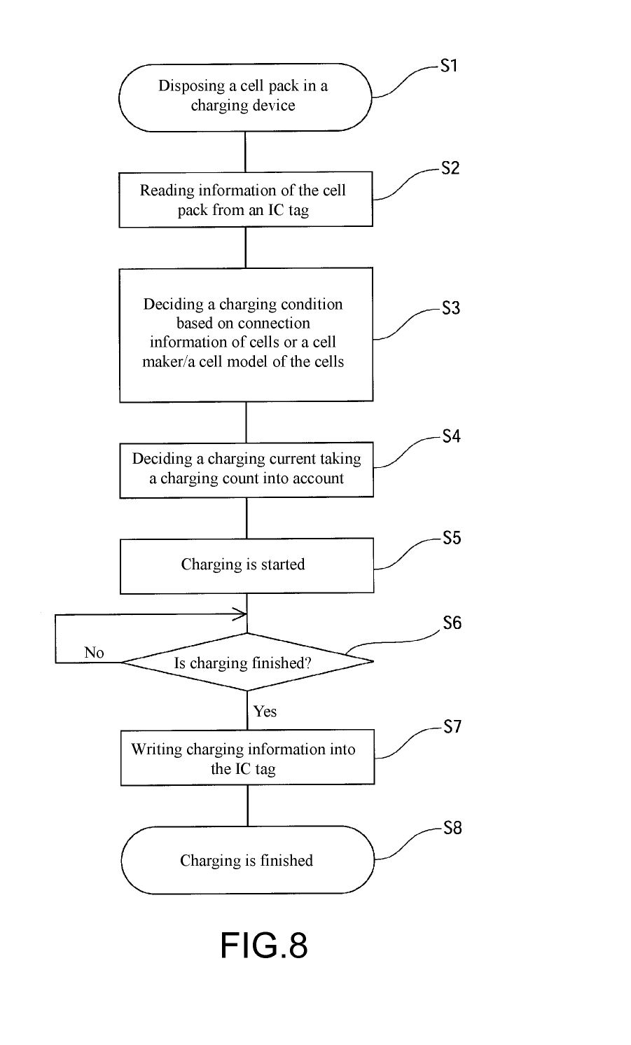

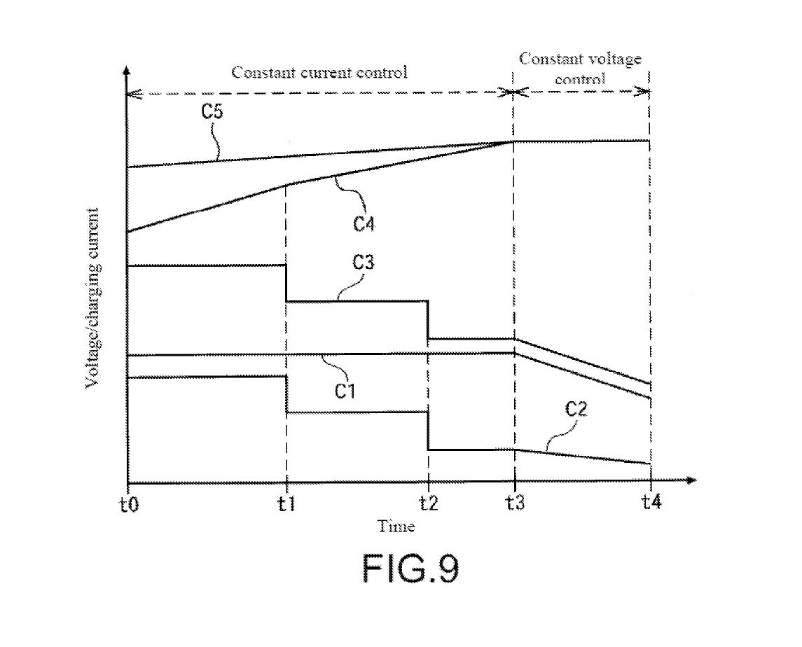

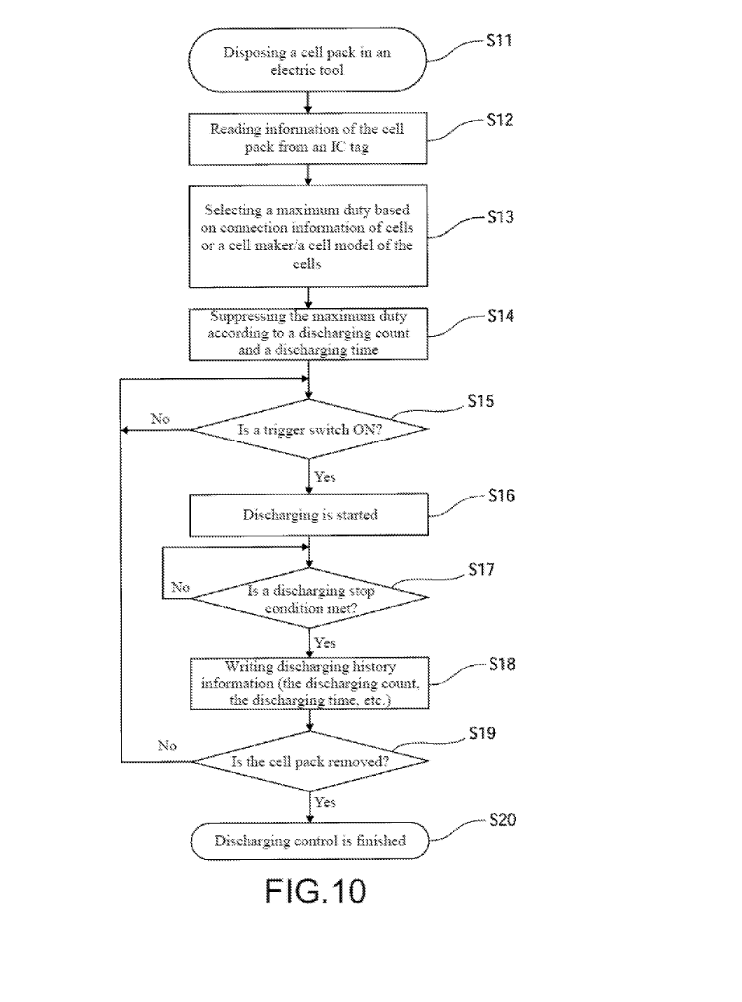

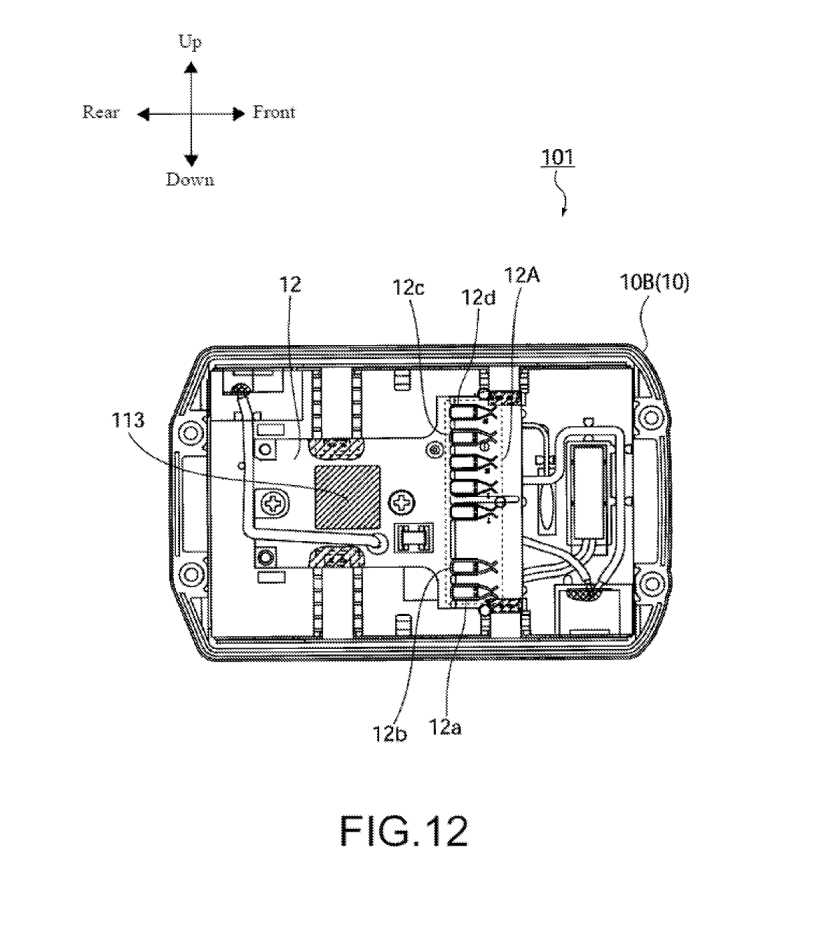

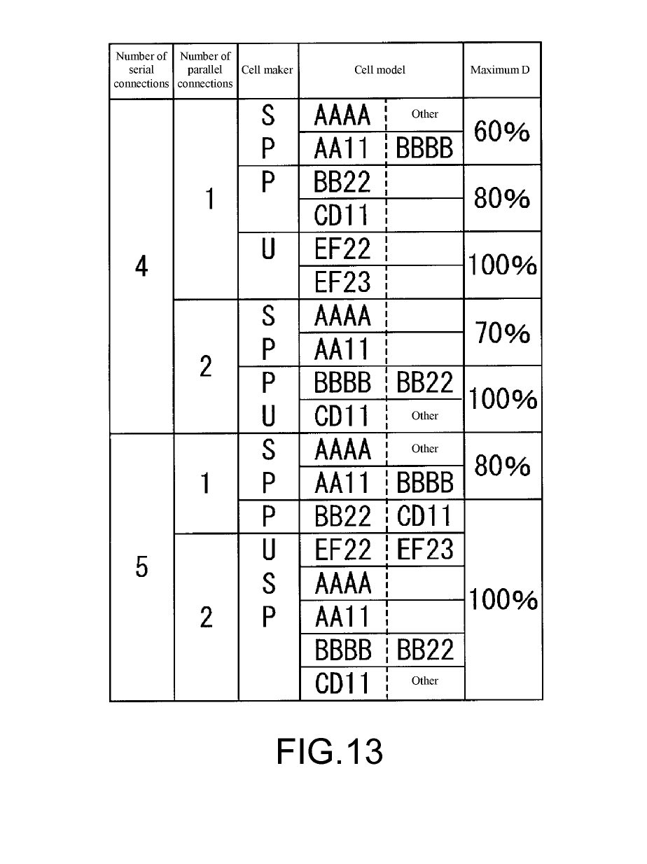

The field N9 is known as “Other information” and stores various information to be used in the charging control or the discharging control (charging/discharging control), such as charging process procedures, discharging process procedures, a table related to the charging current used in the charging process procedure and a table related to the maximum duty used in the discharging process procedure. In the present embodiment, the field N9 stores the discharging process procedures processed according to the flowchart shown in FIG. 8, the charging process procedures processed according to the flowchart shown in FIG. 12, the first charging current decision table shown in FIG. 9, the second charging current decision table shown in FIG. 10, the maximum duty decision table shown in FIG. 13, a correction value (to be described later) and the likes.

Next, the charging device 2 is described in details below. As shown in FIG. 4, the charging device 2 is mainly constituted by a housing 20, a charging circuit board 21 and a reader/writer 22. Also, FIG. 4 is a diagram illustrating the situation where the cell pack 1 is connected to the charging device 2.

The housing 20 is a portion constituting an outline of the charging device 2 and formed into a substantially cuboid shape by a thermal endurance resin. A charging connection part 20A connectable to the cell pack 1 is formed on a surface of the housing 20 opposite to the cell pack 1. The charging device 2 may be in electrical and mechanical connection with the cell pack 1 by connecting the charging connection part 20A to the equipment connection part 10C of the cell pack 1.

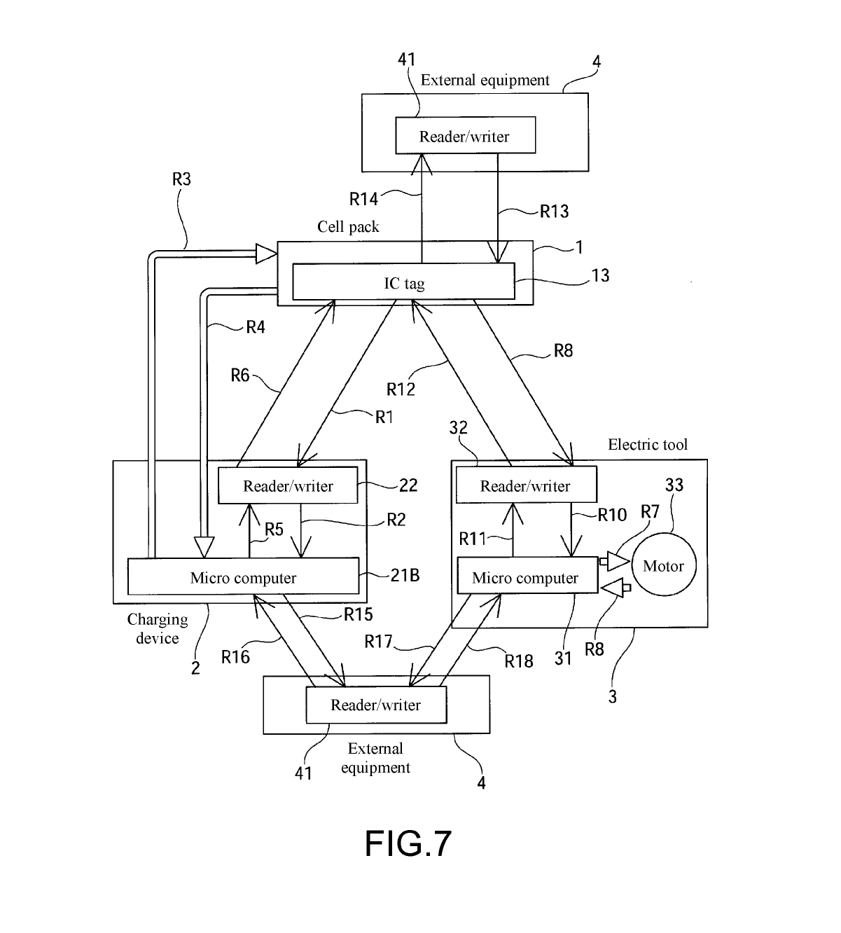

As shown in FIG. 4 and FIG. 7, the charging circuit board 21 is a substrate disposed inside the housing 20 and formed into a substantially rectangular shape in the top view, and mainly includes a charging circuit, and a charging side micro computer 21B. The charging circuit is mounted on the charging circuit board 21, and includes a specific circuit required in the charging and discharging controls of the cell pack 1. Further, the charging circuit is connected to an output terminal part 21A via a wiring, and the output terminal part 21A is connected to the connection terminal part 12A of the cell pack 1 via the charging connection part 20A.

The output terminal part 21A has an output positive terminal, an output negative terminal and a charging side control terminal. When the charging device 2 is connected to the cell pack 1, the output positive terminal is connected to the charging positive terminal 12a of the cell pack 1, the output negative terminal is connected to the charging/discharging negative terminal 12c of the cell pack 1, and the charging side control terminal is connected to the stop signal output terminal 12d of the cell pack 1. In a sliding direction of the cell pack 1 (i.e., the first direction, which is a direction from right to left on the paper surface of FIG. 4, namely, a direction from rear to front shown in FIG. 4), the output terminal 21A is disposed on the front side (the left side on the paper surface of FIG. 4, which is the front side in the direction shown in FIG. 4 that becomes the rear side when inspecting from the charging device 2), and the reader/writer 22 (to be described later) is disposed on the rear side (the right side on the paper surface of FIG. 4, which is the rear side in the direction shown in FIG. 4 that becomes the front side when inspecting from the charging device 2). With such configuration, when the cell pack 1 is slid to connect to the charging device 2, the reader/writer 22 does not cause interferences so the terminals may be connected to each other. The output terminal part 21A is one example of the charging terminal part.

The charging side micro computer 21B is mainly constituted by a plurality input/output ports mounted on the charging circuit board 21, a storage part for storing various data and process procedures and a computing part, and installed with an operating system (OS). The charging side micro computer 21B can process various signals inputted to various input terminals from the charging circuit and the like, and output various signals based on the processed results from various output terminals to the charging circuit, so as to control charging operations. Further, the charging side micro computer 21B can provide a transmission function for transmission with an external equipment (e.g., a personal computer (PC), a tablet terminal, etc.). The charging circuit and the charging side micro computer 21B function as the charging control member. Also, the charging side micro computer 21B functions as the charging information transmission member, and the storage part of the charging side micro computer 21B functions as the charging storage part.

The reader/writer 22 is a device capable of reading the cell information stored in the IC tag 13 of the cell pack 1 and updating (modifying, writing, etc.) the cell information stored in the IC tag 13 through the non-contact transmission, and is connected to the charging side micro computer 21B. The reader/writer 22 is disposed on an inner surface of the housing 20 in a manner overlapping the IC tag 13 when inspecting from the vertical direction after the cell pack 1 is connected to the charging device 2. The reader/writer 22 functions as the reading part and the updating part.

Next, the charging control of the charging device 2 for the cell pack 1 is described below with reference to the flowchart shown in FIG. 8 and the related illustration shown in FIG. 7. In addition, the charging device 2 performs the charging process shown by the flowchart in FIG. 8 according to the charging process procedures read from the IC tag 13.

In S1, when the cell pack 1 is connected to the charging device 2 as shown by the connection state in FIG. 4, the cell information stored in the IC tag 13 of the cell pack 1 is read by the reader/writer 22 of the charging device 2 (S2). In S2, all the cell information is read by the reader/writer 22 and stored in the storage part of the charging side micro computer 21B. The stored cell information is to be used in the charging control. Further, S2 corresponds to an arrow R1 and an arrow R2 shown in FIG. 7.

In S3, the charging side micro computer 21B decides a charging condition based on the cell information read from the IC tag 13. The charging condition is decided by deciding the charging current after the charging voltage is decided.

The charging voltage is decided based on the maximum charging voltage and the number of serial connections in the read cell information. Specifically, the charging voltage is the maximum charging voltage multiplied by the number of serial connections. In the present embodiment, the charging voltage is 19.0 V (3.80/cell×5 cells).

The charging current is decided according to the first charging current decision table in the read cell information as shown in FIG. 9. The first charging current decision table is a table for deciding a reference charging current based on the information pertaining to the cell group 11, the cells 11A constituting the cell group 11 and the model of the charging device without taking the charging count into account. In the present embodiment, the cell group 11 has the number of parallel connections being 1, the cell maker being S, the cell model being AAAA, the rated cell voltage being 3.60 V, and the model of the charging device being CG-100. Accordingly, the reference charging current is 1.5 A. In addition, the first charging current decision table is pre-stored in the storage part of the charging side micro computer of the charging device 2.

In this way, it can be known that the first charging current decision table is configured by, for example, determining the charging current suitable for charging based on the information pertaining to the cell group 11, the cells 11A constituting the cell group 11, and the model of the charging device 2. Further, if the model of the charging device is different, a performance (i.e., a maximum output current) of the charging device may also be different. Therefore, the first charging current decision table is determined for maximizing the performance of the charging device. In addition, the maximum output currents of the different the charging device are CG-100<CG-200<CG-300<CG-400<CG-500<CG-600.

After the charging condition is decided in S3, the charging current is further decided taking the charging count into account (correcting the charging current based on the charging count) in S4. Specifically, the charging current is decided according to the second charging current decision table.

The second charging current decision table is a table for deciding a reference charging current based on information pertaining to the cell group 11, the cells 11A constituting the cell group 11 and the model of the charging device with the charging count taken into account. In the present embodiment, the number of serial connections of the cell group 11 is 1, the cell maker is S, the cell model is AAAA, and the rated cell voltage is 3.60 V. For example, when the charging count is 250, the finally decided charging current is 1.5 A. Also, in the present embodiment, for example, if the charging current is 1100, the finally decided charging current is 1.0 A. That is, the second charging current decision table is configured by reducing the charging current as the charging count becomes more.

Accordingly, the deterioration degree of the cells 11A may be predicted according to the charging count in order to decide the charging current (correcting the charging current decided in S3 according to the deterioration degree in S4). In this way, the loading the cells 11A may be reduced during charging so the long life of the cells 11A may be achieved. Moreover, in the present embodiment, although it is described that the deterioration degree of the cells 11A is determined according to the charging count, the deterioration degree of the cells 11A may also be determined according to the charging count together with the charged time. By doing so the deterioration degree may be determined more accurately.

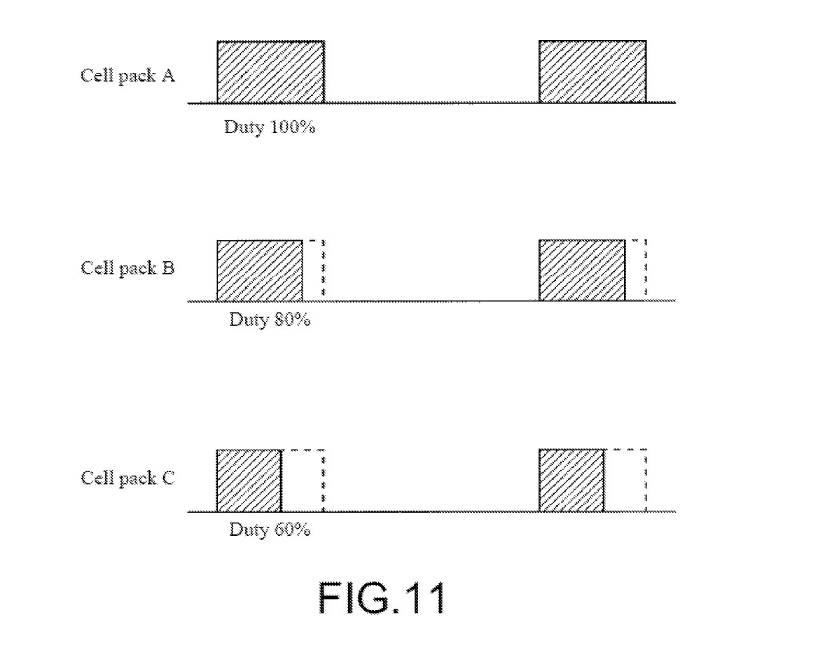

After the charging condition is finally decided in S4, charging is started by using the charging condition in S5. The constant current constant voltage control is used to perform charging. FIG. 11 is a diagram showing changes over time of the current and the voltage in the charging control, in which five different charging controls (i.e., controls C1 to C5) are illustrated as an example.

The control C1 is the charging control performed according to the charging condition decided in the present embodiment and the charging process procedures. It should be noted that, only the charging current during charging in the control C1 is illustrated. The control C1 refers to the charging process procedures stored in the field N9 in IC tag 13. The control C1 is a constant current constant voltage charging control as described below. When charging is started (t0), the charging current is maintained at 1.5 A while charging (the constant current control). After the charging voltage reaches 19.0 V (t3), the charging voltage is maintained at 1.90 V while charging continuously (the constant voltage control). Charging is finished when the charging current reaches a predetermined value during the constant voltage control. The control C1 corresponds to an arrow R3 shown in FIG. 7.

For example, if the control C2 or the control C3 is described in the charging process procedures stored in the field N9 of the IC tag 13, the charging control is performed according to the control C2 or the control C3. The control C2 and the control C3 are a constant current constant voltage charging control as described below. When charging is started (t0), the charging current is maintained at a predetermined value while charging (the constant current control). Each time when the charging voltage exceeds a predetermined value (t1, t2), the charging current is sequentially reduced during the constant current control. After the charging voltage reaches a voltage value for transition to the constant voltage control (t3), the charging voltage is maintained at such voltage value while charging continuously (the constant voltage control). Charging is finished when the charging current reaches a predetermined value during the constant voltage control.

Similarly, if the control C4 or the control C5 is described in the charging process procedures stored in the field N9 of the IC tag 13, the charging control is performed according to the control C4 or the control C5. The control C4 is a charging control as described below. When charging is started (t0), the charging voltage is gradually increased. After the charging voltage reaches a predetermined value (t1), a rising gradient of the charging voltage is controlled to be less than that in t0 to t1 while charging. After the charging voltage reaches a voltage value for transition to the constant voltage control (t3), the charging voltage is maintained at such voltage value while charging continuously (the constant voltage control). Charging is finished when the charging current reaches a predetermined value during the constant voltage control. The control C5 is a charging control as described below. When charging is started (t0), the charging voltage is gradually increased with a fixed gradient. After the charging voltage reaches a voltage value for transition to the constant voltage control (t3), the charging voltage is maintained at such voltage value while charging continuously (the constant voltage control). Charging is finished when the charging current reaches a predetermined value during the constant voltage control.

In addition, when the cells 11A become over-charged or over-discharged during the charging control, a stop signal for stopping charging is outputted to the charging side micro computer 21B from the stop signal output terminal 12d of the cell pack 1 via the charging side control terminal of the charging device 2. In the case where the stop signal is outputted from the cell pack 1, the charging device 2 stops charging. The process of outputting the stop signal corresponds to an arrow R4 shown in FIG. 7.

When charging is finished in the control C1 or charging is stopped by the stop signal, charging is finished (in the “Yes” in S6). When charging is not finished and the stop signal is not outputted, S6 is repeated (n the “No” in S6).

When charging is finished, the charging history is updated in S7 (by writing the IC tag 13). Specifically, the charging side micro computer 21B uses the reader/writer 22 to update the charging count, the model of the charging device 2 used in charging, the over-charged count and the over-discharged count stored in the field N7 of the IC tag 13. The process of the charging side micro computer 21B for writing the IC tag 13 corresponds to an arrow R5 and an arrow R6 shown in FIG. 7. After writing the IC tag 13 in S7, charging is finished in S8.

In the following, the electric tool 3 is described in details. As shown in FIG. 5 and FIG. 7, the electric tool 3 includes a housing 30, a tool side micro computer 31, a reader/writer 32, a motor 33 and a discharging control circuit for driving the motor 33 and performing a driving control (i.e., controlling discharging of the cell pack 1). Further, FIG. 5 is a diagram illustrating the situation where the cell pack 1 is connected to the electric tool 3.

As shown in FIG. 5, the housing 30 is a part constituting an outline of the electric tool 3 and including a handle 30A. The handle part 30A is a portion extending along the vertical direction, handled by users. A tool connection part 30B is formed below the handle part 30A. Further, the handle part 30A includes a trigger switch for driving the motor 33 through operations of the users. The tool connection part 30B is configured to be connectable to the equipment connection part 10C of the cell pack 1, and includes an input positive terminal, an input negative terminal for inputting a discharging voltage from the cell pack 1, and a tool side control terminal. The input positive terminal, the input negative terminal and the tool side control terminal function as the tool terminal part.

When the tool connection part 30B is connected to the equipment connection part 10C of the cell pack 1, the input positive terminal is connected to the discharging positive terminal 12b of the cell pack 1, the input negative terminal is connected to the charging/discharging negative terminal 12c of the cell pack 1, and the tool side connection control terminal is connected to the stop signal output terminal 12d. In a sliding direction of the cell pack 1 (i.e., the first direction which is a direction from right to left on the paper surface of FIG. 5, namely, a direction from rear to front shown in FIG. 5), the tool connection part 30B is disposed on the front side (the left side on the paper surface of FIG. 5 that becomes the rear side when inspecting from the tool), and the reader/writer 32 (to be described later) is disposed on the rear side (the right side on the paper surface of FIG. 5, which is the rear side in the direction shown in FIG. 5 that becomes the front side when inspecting from the tool). With such configuration, when the cell pack 1 is slid to connect to the electric tool 3, the reader/writer 32 does not cause interferences so the terminals may be connected to each other.

As shown in FIG. 7, the tool side micro computer 31 is mounted on a substrate inside the electric tool 3, mainly constituted by a plurality of input/output terminals, a storage part for storing various data and process procedures and a computing part, and installed with an OS (operating system). The tool side micro computer 31 can process various signals inputted to various input terminals from the discharging control circuit and the like, and output various signals based on the processed results from various output terminals to the discharging control circuit, so as to control discharging operations. Further, the tool side micro computer 31 can provide a transmission function for transmission with an external equipment (e.g., a PC, a tablet terminal, etc.). The discharging control circuit and the tool side micro computer 31 function as the discharging control member. Also, the tool side micro computer 31 functions as the discharging information transmission member, and the storage part of the tool side micro computer 31 functions as the discharging storage part.

The reader/writer 32 is a device capable of reading the cell information stored in the IC tag 13 of the cell pack 1 and updating (modifying, writing, etc.) the cell information stored in the IC tag 13 through the non-contact transmission, and is connected to the tool side micro computer 31. The reader/writer 32 is disposed on an inner surface of a lower portion of the handle part 30A in a manner overlapping the IC tag 13 of the cell pack 1 when inspecting from the vertical direction after the cell pack 1 is connected to the electric tool 3. The reader/writer 32 functions as the reading part and the updating part.

The motor 33 is a three phase DC (direct current) brush less motor, which is driven by the discharging control circuit. Further, the discharging control circuit includes a switch circuit having six field effect transistors (FETs), and changes a predetermined On time of the FETs based on the signals from the tool side micro computer 31 (changing the duty) to adjust the amount of power supplied to the motor 33. That is to say, the discharging control circuit can perform a pulse width modulation (PWM) control. Further, the discharging control circuit includes a rotational speed detection part for detecting a rotational speed of the motor 33. The rotational speed detection part outputs the rotational speed of the motor 33 to the tool side micro computer 31. As shown in FIG. 7, an arrow R7 corresponds to the discharging control including the PWM control, and information of rotational speed from the rotational speed detection part corresponds to an arrow R8.

Next, the driving control of the electric tool 3 is described below with reference to the flowchart shown in FIG. 12 and related illustration shown in FIG. 7. In addition, the electric tool 3 performs the charging process shown by the flowchart in FIG. 12 according to the discharging process procedures read from the IC tag 13.

In S11, when the cell pack 1 is connected to the electric tool 3 as shown by the connection state in FIG. 5, the cell information stored in the IC tag 13 of the cell pack 1 is read by the reader/writer 32 of the electric tool 3 (S12). In S12, all the cell information is read by the reader/writer 32 and stored in the storage part of the tool side micro computer 31. The stored cell information is to be used in the discharging control. Further, S12 corresponds to an arrow R9 and an arrow R10 shown in FIG. 7.

In S13, the tool side micro computer 31 decides the maximum duty based on the cell information read from the IC tag 13. The maximum duty is decided according to the maximum duty decision table in the cell information as shown in FIG. 13. The maximum duty decision table is a table for deciding a reference maximum duty based on the information pertaining to the number of serial connections, the number of parallel connections, the cell maker, the cell model of the cells 11A constituting the cell group 11 without taking the discharging count and the discharged time into account. In the present embodiment, the cell group 11 has the number of serial connections being 5, the number of parallel connections being 1, the cell maker being S, and the cell model being AAAA. Accordingly, the reference maximum duty is 80%. In addition, the duty refers to a duty of the six FETs in an inverter circuit (the switch circuit) for driving the motor 33.

That is to say, the maximum duty decision table is configured by, for example, determining the duty suitable for discharging based on the information pertaining to the cell group 11, the cells 11A constituting the cell group 11, and the model of the charging device 2.

After the reference maximum duty is decided in S13, the maximum duty is further decided with the charging count and the total charged time taken into account in S14 (correcting the maximum duty based on the discharging count and the total discharged time). It can be predicted that, the deterioration degree of the cells 11A becomes higher as the discharging count and discharged time become more. Therefore, in S14, the correction value corresponding to the deterioration degree of the cell pack 1 is decided based on the discharging count and the total discharged time, and the maximum duty decided in S13 is then multiplied by said correction value. For example, in the case where the discharging count is greater than 500 and less than 700 and the total discharged time is more than 250 minutes and less than 350 minutes, the correction value may be set to 0.9, and a value obtained by multiplying the reference maximum duty decided in S13 by 0.9 may be used as a final maximum duty (80%×0.9=72%). Further, if the discharging count is greater than 700 and less than 800 and the total discharged time is more than 350 minutes and less than 400 minutes, the correction value may be set to 0.8, and a value obtained by multiplying the reference maximum duty decided in S13 by 0.8 may be used as the final maximum duty (80%×0.8=64%). Preferably, the correction value becomes smaller as the charging count and the charged time become more.

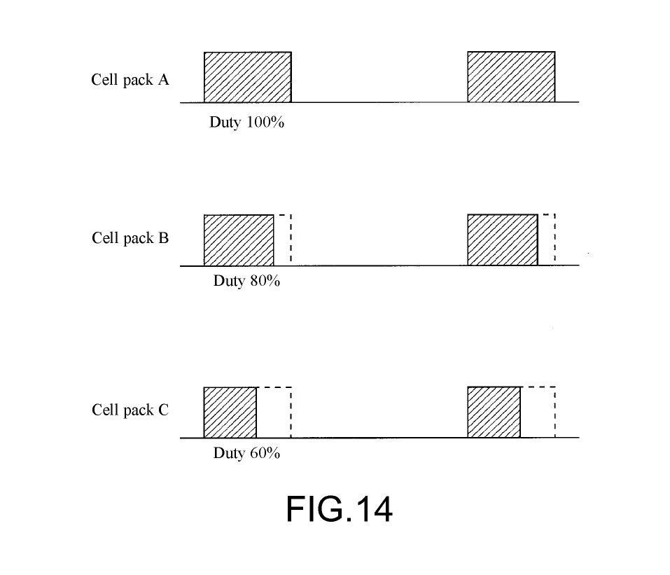

FIG. 14 is a diagram illustrating maximum duties decided in the discharging control of the electric tool 3 for cell packs A to C with different deterioration degrees in the cells, and illustrating pulse widths outputted to the FETs of the switch circuits (the pulse widths of the signal from the tool side micro computer 31). In the case of the cell pack A, the deterioration degree is at the lowest so the maximum duty is decided to be 100%. In the case of the cell pack B, the deterioration degree is at the middle so the maximum duty is decided to be 80%. In the case of the cell pack C, the deterioration degree is at the highest so the maximum duty is decided to be 60%.

In this way, the deterioration degree of the cells 11A may be predicted according to the discharging count and the discharged time in order to decide the maximum duty (by correcting the maximum duty decided in S13 according to the deterioration degree in S14). In this way, the loading the cells 11A may be reduced during discharging so the long life for the cells 11A may be achieved. Moreover, in the present embodiment, although it is described that the deterioration degree of the cells 11A is determined according to the discharging count together with the discharged time, the deterioration degree of the cells 11A may also be determined according to charging count alone as well as according to the discharged time alone.

After the maximum duty is finally decided in S14, whether trigger switch is ON is determined in S15. If the trigger switch is not ON (if “No” in S15), S15 is repeated until the trigger switch is ON. Otherwise, if the trigger switch is ON (if “Yes” in S15), discharging is started in S16 (by starting the driving control for the motor 33). When discharging is started, the PWM control is performed on the motor 33 without going over the range of the maximum duty finally decided in S14.

In addition, when the cells 11A become over-charged or over-discharged during the discharging control, a stop signal for stopping charging is outputted to the charging side micro computer 21B from the stop signal output terminal 12d of the cell pack 1 via the tool side control terminal of the electric tool 3.

In S16, after discharging is started, whether a discharging stop condition is met is determined in S17. The discharging stop condition refers to a condition where the trigger switch is OFF or a condition where the stop signal is outputted from the cell pack 1. If the discharging stop condition is not met (if “No” in S17), S17 is repeated until the discharging stop condition is met.

Otherwise, if the discharging stop condition is met (if “Yes” in S17), discharging is finished and the discharging history information is updated (by writing the IC tag 13) in S18. Specifically, the tool side micro computer 31 uses the reader/writer 32 to update the discharging count, the discharged time, the model of the electric tool 3 used in discharging, the over-charged count and the over-discharged count stored in the field N7 of the IC tag 13. The process of the tool side micro computer 31 for updating the discharging history information stored in the IC tag 13 corresponds to an arrow R11 and an arrow R12 shown in FIG. 7. In addition, the model of the electric tool 3 is stored in the storage part of the tool side micro computer 31.

After writing the IC tag 13 is finished in S18, whether the connection between the cell pack 1 and the electric tool 3 is disconnected is determined in S19. If it is determined that the connection is not disconnected, S15 to S19 are repeated. Otherwise, if it is determined that the connection is disconnected, the discharging control is finished in S20.

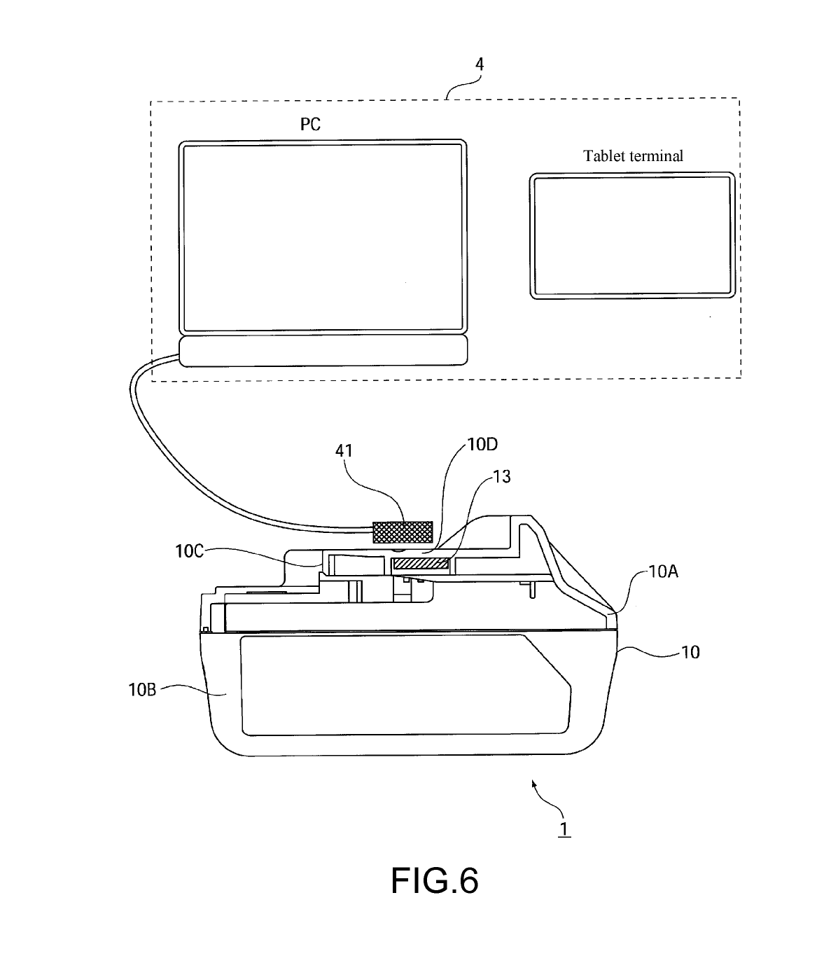

Next, an external equipment 4 is described in details below. FIG. 6 is a diagram illustrating the external equipment 4 connected to a reader/writer 41 capable of reading and writing the cell information stored in the IC tag 13. The external equipment 4 is, for example, a PC or a tablet terminal. The external equipment 4 can read the cell information stored in the IC tag 13 by using the connected reader/writer 41, and the cell information can display on a LCD screen included by the external equipment. The process of the external equipment 4 for reading the cell information stored in the IC tag 13 corresponds to an arrow R13 in FIG. 7.

In this way, in the cell pack 1 of the present embodiment, because the cell information stored in the IC tag 13 may be displayed on the LCD monitor, the convenience may be improved since the users no longer need to take the cell group 11 or the cells 11A out from the cell pack 1 in order to check the model and the like. Further, the reader/writer 41 may be used to update (modify, write, etc.) the cell information stored in the IC tag 13. For example, the appropriate charging/discharging control may be achieved by updating the charging process procedures or the discharging process procedures stored in the IC tag 13 to the latest. The process of the external equipment 4 for updating the cell information stored in the IC tag 13 corresponds to an arrow R14 in FIG. 7.

Also, the external equipment 4 can use the transmission function of the charging side micro computer 21B of the charging device 2 to display the cell information stored in the storage part of the charging side micro computer 21B on the LCD screen. The process of the external equipment 4 for reading the cell information stored in the charging device 2 corresponds to an arrow R15 in FIG. 7. Similarly, the transmission function of the tool side micro computer 31 of the electric tool 3 may be used to display the information stored in the storage part of the tool side micro computer 31 on the LCD screen. The process of the external equipment 4 for reading the information stored in the electric tool 3 corresponds to an arrow R17 in FIG. 7.

Accordingly, the external equipment 4 can use the transmission function the charging side micro computer 21B of the charging device 2 to update (modify, write, etc.) the information stored in the storage part of the charging side micro computer 21B. The process of the external equipment 4 for updating the information stored in the charging device 2 corresponds to an arrow R16 in FIG. 7. Similarly, the transmission function of the tool side micro computer 31 of the electric tool 3 may be used to update (modify, write, etc.) the information stored in the storage part of the tool side micro computer 31. The process of the external equipment 4 for reading the cell information stored in the electric tool 3 corresponds to an arrow R18 in FIG. 7.

As described above, according to the embodiments of the invention, the cell pack 1 includes: the cell group 11, including one or more cells 11A; the case 10, accommodating the cell group 11 and provided with the equipment connection part 10C, the equipment connection part 10C being connectable to the charging device 2 for charging the cell group 11 and connectable to the electric tool 3 driven by discharging of the cell group 11; and the IC tag 13, for storing the cell information pertaining to the cell group 11. As such, the cell information pertaining to the cell group 11 (i.e., the rated voltage, the number of parallel connections and the number of serial connections of the cells 11A constituting the cell group 11) may be stored in the IC tag 13. In this way, because the charging device 2 or the electric tool 3 can read the information stored in the IC tag 13, the charging device 2 or the electric tool 3 can accurately determine the type of the cell group 11 to achieve the appropriate charging control or the appropriate discharging control. Further, in addition to the rated voltage, the number of parallel connections and the number of serial connections of the cells 11A constituting the cell group 11, the IC tag 13 can also store various information including the rated charging current, the maximum charging current, the rated discharging current, the maximum discharging current, the termination current, etc., as the cell information pertaining to the cell group. Therefore, the stored cell information may be used in the charging control or the discharging control to achieve the extreme fine control so the appropriate charging control or the appropriate discharging control may be performed. Further, the cell group 11, the circuit board 12 and the IC tag 13 are disposed in the sequence starting from the bottom inside the case 10. Because the IC tag 13 is disposed on the position near the connection target, the information of the IC tag 13 may be reliably read by the connection target. Also, since the IC tag 13 is disposed to be less protruded above than the upper end of the connection terminal part 12A, the cell pack 1 does not become larger.

Further, the charging device 2 includes: the reader/writer 22, capable of reading the cell information stored in the IC tag 13; and the charging circuit and the charging side micro computer 21B, capable of performing the charging control based on the cell information. As such, the charging device 2 can read the cell information stored in the IC tag 13 of the cell pack 1 so as to perform the charging control for the cell group 11 based on the cell information. Thus, the cell group 11 may be charged with the appropriate charging control corresponding to the type of the cell group 11. Further, when the cell pack 1 is connected to the charging device 2, because the IC tag 13 and the reader/writer 22 are located in an overlapping manner when inspecting from the vertical direction, the distance between the two may be reduced so the information of the IC tag 13 may be reliably read.

Also, because the cell information includes the charging history information, the deterioration degree of the cell group 11 or the cells 11A may be determined according to the charging history information. In this way, the charging control taking the deterioration degree into account becomes viable so the more appropriate charging control may be performed.

Further, the electric tool 3 includes: the reader/writer 32, capable of reading the cell information stored in the IC tag 13; and the discharging control circuit and the tool side micro computer 31, capable of performing the discharging control based on the cell information. As such, the charging device 3 can read the cell information stored in the IC tag 13 of the cell pack 1 so as to perform the discharging control for the cell group 11 based on the cell information. Thus, the appropriate discharging control corresponding to the type of the cell group 11 accommodated in the cell pack 1 may be performed. Further, when the cell pack 1 is connected to the electric tool 3, because the IC tag 13 and the reader/writer 32 are located in an overlapping manner when inspecting from the vertical direction, the distance between the two may be reduced so the information of the IC tag 13 may be reliably read.

Also, because the cell information includes the discharging history information, the deterioration degree of the cell group 11 or the cells 11A may be determined according to the discharging history information. In this way, the discharging control taking the deterioration degree into account becomes viable so the more appropriate discharging control may be performed.

Further, because the IC tag 13 is disposed on the inner surface, the attachment of liquid drop, dust and dirt as well as the impact from outside the case 10 may be suppressed. Accordingly, the long life of the IC tag 13 may be achieved.

Further, the case 10 has the opposite wall 10D. When the equipment connection part 10C is connected to the charging device 2 or the electric tool 3, the opposite wall 10D is opposite to the charging device 2 or the electric tool 3. Because the IC tag 13 is disposed on the opposite wall 10D, the IC tag 13 may be located near the charging device 2 or the electric tool 3. Thus, the charging device 2 or the electric tool 3 can read cell information stored in the IC tag 13 more reliably and easily.

Moreover, the circuit board 12 is further provided and mounted with the electrical circuit connected to the cell group 11 in the case 10. Also, because the IC tag 13 is disposed on the circuit board 12, the IC tag 13 may be mounted on the circuit board 12 in advance during the assembly procedure before the circuit board 12 is accommodated in the case 10. Thus, the assemblability of the cell pack 1 may be improved.

According to the embodiments of the invention, the charging device 2 includes: the reader/writer 22, capable of reading the cell information stored in the IC tag 13; and the charging circuit and the charging side micro computer 21B, capable of performing the charging control for the cell group 11 based on the cell information. As such, the cell information pertaining to the cell group stored in the IC tag 13 included by the cell pack 1 may be read so the charging control may be performed based on the cell information. Thus, the charging device 2 can appropriately charge the cell group 11 which serves as the charging target.

Further, because the charging device 2 includes the reader/writer 22 capable of updating the cell information stored in the IC tag 13, the cell information may be updated into newer information. Thus, the charging control may be performed based on the new information to achieve the more appropriate charging control.

According to the embodiments of the invention, the electric tool 3 includes: the reader/writer 32, capable of reading the cell information stored in the IC tag 13; and the discharging control circuit and the tool side micro computer 31, capable of performing the discharging control for the cell group 11 based on the cell information. With such configuration, the cell information pertaining to the cell group 11 stored in the IC tag 13 included by the cell pack 1 may be read so the discharging control may be performed based on the cell information. Thus, the electric tool 3 can perform the appropriate discharging control.

Further, because the electric tool 3 includes the reader/writer 32 capable of updating the cell information stored in the IC tag 13, the cell information may be updated into newer information. Thus, the more appropriate discharging control based on the new formation may be achieved.

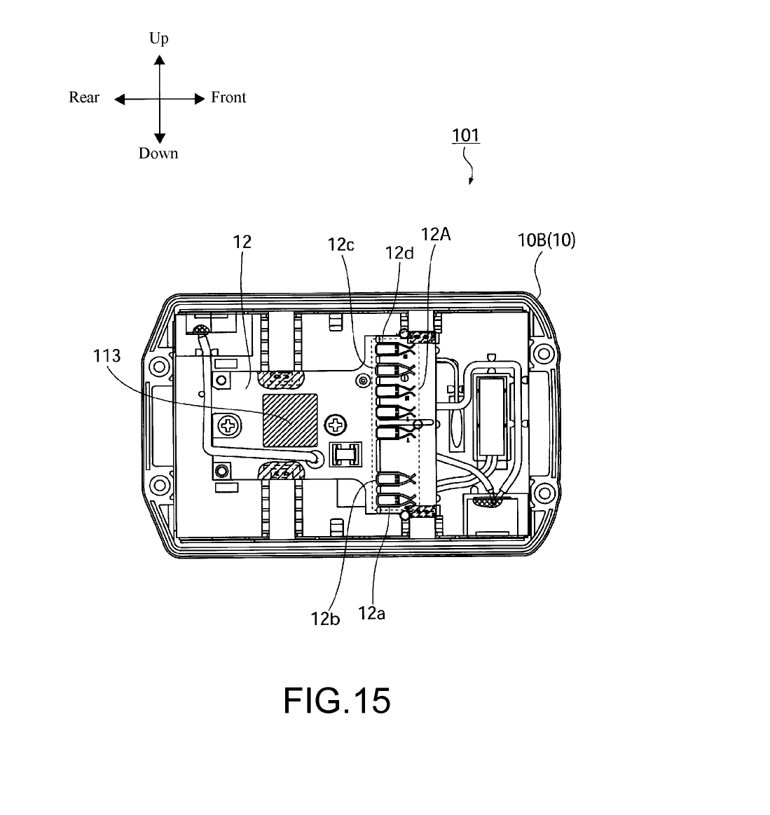

Next, a cell pack 101 according to the modification example in one embodiment of the invention is described below with reference to FIG. 15. Components identical to the cell pack 1 in the embodiments of the invention are marked with the same reference numbers and related descriptions thereof are omitted hereinafter. It is noted that only those components different from the foregoing embodiments are described here. Also, in the cell pack 1 and the cell pack 101, the cell information stored in the IC tag, the connection with the charging device and charging control thereof and the connection with the electric tool 3 are of the same, and the only difference is the positions for disposing the IC tag. As shown in FIG. 15, an IC tag 113 of the cell pack 101 is disposed on the upper surface of the circuit board 12 (a surface on the opposite side of the cell group 11). Accordingly, by adopting the structure in which the IC tag 113 is disposed on the upper surface of the circuit board 12, the IC tag may be mounted on the circuit board 12 in advance before the circuit board 12 is accommodated in the case. Thus, the assemblability of the cell pack 101 may be improved.

The cell pack, the charging device and the electric tool of the invention are not limited by the provided embodiments, and various modifications may be made without changing the spirit in the scope of the subject matters in the invention. For example, in the embodiments of the invention, the charging process procedures and discharging process procedure are pre-stored in the IC tag 13 so the charging device 2 or the electric tool 3 can read those procedures and use the same in the charging control or the discharging control. However, the charging process procedures may also be stored in the charging side micro computer 21B of the charging device 2, or the discharging process procedures may also be stored in the tool side micro computer 31 of the electric tool 3.

Moreover, in the embodiments of the invention, the rated capacity information stored in the field N6 of the IC tag 13 is not used in the charging control or the discharging control. Nonetheless, the rated capacity information may also be used in the charging control or the discharging control. By doing so, a driving time or an elapsed time until the cells are fully charged may be calculated according to the voltage and the rated capacity of the connected cell group 11.

### REFERENCE NUMERALS

1, 101: cell pack
2: charging device
3: electric tool
4: external equipment
10: case
10C: equipment connection part
10D: opposite wall
11: cell group
11A: cells
12: circuit board
12A: connection terminal part
13, 113: IC tag
21B: charging side micro computer
22, 32: reader/writer
30: housing
30A: handle
30B: tool connection part
31: tool side micro computer
33: motor

1. A cell pack, comprising:
a cell group, comprising one or more secondary cells;
a case, for accommodating the cell group and provided with a connection part, the connection part being connectable to a charging device for charging the cell group and connectable to an electric tool driven by discharging of the cell group; and
an integrated circuit tag, for storing cell information pertaining to the cell group.

2. The cell pack according to claim 1, wherein the integrated circuit tag is disposed on an inner surface of the case, the case has an opposite wall, the opposite wall is opposite to the charging device or the electric tool when the connection part is connected to the charging device or the electric tool, and the integrated circuit tag is disposed on the opposite wall.

3. The cell pack according to claim 1, further comprising: a substrate, accommodated in the case and mounted with a circuit part connected to the cell group, the integrated circuit tag being disposed on the substrate.

4. A cell pack, comprising:
a cell group, comprising one or more secondary cells;
a circuit board, disposed above the cell group and connected to the secondary cells;
a case, for accommodating the cell group and the circuit board and provided with a connection part; and
an integrated circuit tag, disposed above the circuit board and storing cell information pertaining to the cell group.

5. (canceled)

6. The cell pack according to claim 4, wherein the connection part has a terminal, the terminal has one end connected to the circuit board and another end connected to an external equipment, and the integrated circuit tag is disposed inside the case on an upper portion of the another end of the terminal or on a position lower than the upper portion in a vertical direction.

7. A cell pack, comprising:
a cell group, comprising one or more secondary cells;
a case, for accommodating the cell group and provided with a connection terminal part connected to a connection target; and
an integrated circuit tag, for storing cell information pertaining to the cell group,
wherein the case is configured to connect the connection target by sliding along a first direction, the connection terminal part is disposed on a front side and the integrated circuit tag is disposed on a rear side in the first direction.

8. A charging device, connectable to a cell pack, the cell pack comprising a cell group and an integrated circuit tag, the cell group comprising one or more secondary cells, the integrated circuit tag storing cell information pertaining to the cell group, the charging device comprising:
a reading member, capable of reading the cell information stored by the integrated circuit tag; and
a charging control member, performing a charging control for the cell group based on the cell information read by the reading member.

9. The charging device according to claim 8, wherein the reading member is disposed opposite to the integrated circuit tag when the cell pack is connected to the charging device.

10. The charging device according to claim 9, wherein the cell pack is configured to connect above the charging device, and the integrated circuit tag and the reading member are disposed in an overlapping manner when inspecting from a vertical direction.

11. A charging device, connectable to a cell pack, the cell pack comprising a cell group, a connection terminal part and an integrated circuit tag, the cell group comprising one or more secondary cells, the connection terminal part being connected to the cell group, the integrated circuit tag storing cell information pertaining to the cell group, the charging device comprising:
a charging terminal part, connected to the connection terminal part;
a reading member, capable of reading the cell information stored by the integrated circuit tag; and
a charging control member, performing a charging control for the cell group based on the cell information read by the reading member, and configured to connect the connection terminal part to the charging terminal part by sliding the cell pack along a first direction, the charging terminal part being disposed on a front side and the reading member being disposed on a rear side in the first direction.

12. An electric tool, connectable to a cell pack, the cell pack comprising a cell group and an integrated circuit tag, the cell group comprising one or more secondary cells, the integrated circuit tag storing cell information pertaining to the cell group, the electric tool comprising:
a reading member, capable of reading the cell information stored by the integrated circuit tag; and
a discharging control member, performing a discharging control for the cell group based on the cell information read by the reading member.

13. The electric tool according to claim 12, wherein the reading member is disposed opposite to the integrated circuit tag when the cell pack is connected to the electric tool.

14. The electric tool according to claim 13, wherein the cell pack is configured to connect below the electric tool, and the integrated circuit tag and the reading member are disposed in an overlapping manner when inspecting from a vertical direction.

15. An electric tool, connectable to a cell pack, the cell pack comprising a cell group, a connection terminal part and an integrated circuit tag, the cell group comprising one or more secondary cells, the connection terminal part being connected to the cell group, the integrated circuit tag storing cell information pertaining to the cell group, the electric tool comprising:
a tool terminal part, connected to the connection terminal part;
a reading member, capable of reading the cell information stored by the integrated circuit tag; and
a discharging control member, performing a discharging control for the cell group based on the cell information read by the reading member, and configured to connect the connection terminal part to the tool terminal part by sliding the cell pack along a first direction, the tool terminal part being disposed on a front side and the reading member being disposed on a rear side in the first direction.

16. The cell pack according to claim 6, wherein the integrated circuit tag is disposed avoiding the terminal in a vertical direction.
